(19) United States
(12) Patent Application Publication
(10) Pub. No.: US 2012/0307488 A1
(43) Pub. Date: Dec. 6, 2012

(54) Substrate for a Lighting Module and Lighting Module

(75) Inventor: Thomas Preuschl, Sinzing (DE)

(73) Assignee: Osram AG, Munich (DE)

(21) Appl. No.: 13/578,789

(22) PCT Filed: Jan. 24, 2011
(86) PCT No.: PCT/EP11/50890

§ 371 Date: Aug. 13, 2012

(30) Foreign Application Priority Data
Feb. 12, 2010 (DE) 10 2010 001 893.7

(51) Int. Cl. F21V 9/00; F21V 21/00

(52) U.S. Cl. 362/231; 362/382

(57) ABSTRACT

A substrate (1; 11; 21) for a lighting module (M), said substrate comprising a plurality of light source mounting slots (DLn), and at least one resistor mounting slot (RLm) for a bridge resistor, wherein the at least one resistor mounting slot (RLm) is in each case connected in parallel with at least one of the light source mounting slots

The invention relates to a substrate for a lighting module, in particular for a LED lighting module, and relates further to a lighting module.

It is known to populate a substrate with electronic components, including a plurality of light-emitting diodes (LEDs). Thermally critical components such as e.g. the LEDs or driver devices should be coupled to the substrate with a minimum possible heat transfer resistance. The substrate can be connected to a heatsink. Such substrates, in which different blocks each having a plurality of LEDs can be controlled and activated separately according to the desired type of illumination (low-beam light, high-beam light, etc.), are known from the automotive sector.

It is the object of the present invention to provide a lighting unit which can be adapted particularly easily to different boundary conditions and in addition can be produced at reasonable cost.

This object is achieved according to the features of the independent claims. Preferred embodiment variants may be derived in particular from the dependent claims.

The object is achieved by means of a substrate for a lighting module, said substrate comprising a plurality of light source mounting slots and at least one resistor mounting slot for a (bridge) resistor, the at least one resistor mounting slot being in each case connected in parallel with at least one of the light source mounting slots. In other words, the object can be achieved by means of a substrate for a lighting module, the substrate comprising n light source mounting slots, in particular LED mounting slots, and at least m resistor mounting slots for bridge resistors, where n>=2, m>=1 and the m resistor mounting slots are in each case connected in parallel with at least one of the n light source mounting slots.

This enables the same substrate to be used for a different number and/or type of light sources. If it is intended not to populate the maximum possible number of light source mounting slots with a respective light source, at least one light source mounting slot can remain vacant. In order to guarantee a flow of current through the other light sources, for every free light source mounting slot a bridge mounting slot electrically connected in parallel therewith is populated with a bridge resistor. In this way the same substrate can be used for different requirements in respect of a lighting current (luminous flux requirement) and only needs to be populated differently. It is also easily possible in this way to set or approximate a desired numerical ratio of different-colored light sources, in particular LEDs, in particular for generating a mixed light. Using the same substrate for different requirements, e.g. in respect of a luminous flux and/or a luminous color, enables the costs per unit thereof to be reduced.

The bridge resistor can be in particular a zero-ohm resistor.

The at least one light source preferably includes at least one light-emitting diode (LED). If a plurality of light-emitting diodes are present, these can radiate light in the same color or in different colors. A color can be monochromatic (e.g. red, green, blue, etc.) or multichromatic (e.g. white). The light radiated by the at least one light-emitting diode can also be an infrared light (IR-LED) or an ultraviolet light (UV-LED). A plurality of light-emitting diodes can generate a mixed light, e.g. a white mixed light. The at least one light-emitting diode can contain at least one wavelength-converting luminescent substance (conversion LED). The at least one light-emitting diode can be present in the form of at least one individually packaged light-emitting diode or in the form of at least one LED chip. The at least one light-emitting diode can be equipped with at least one dedicated and/or collective optical element for beam guidance, e.g. at least one Fresnel lens, collimator, and so forth. Instead of or in addition to inorganic light-emitting diodes, e.g. based on InGaN or AlInGaP, organic LEDs (OLEDs, e.g. polymer OLEDs) can also be used in general. Alternatively, the at least one light source can have e.g. at least one diode laser or another solid-state light source.

The number of resistor mounting slots can generally be less than, equal to or greater than the number of light source mounting slots. If the number of light source mounting slots is equal to the number of resistor mounting slots, each of the light source mounting slots can be bridged or lie electrically in parallel with one of the resistor mounting slots.

If the number of resistor mounting slots is less than the number of light source mounting slots, some of the light source mounting slots can for example be individually bridged and/or a plurality of light source mounting slots can be collectively bridged. If the number of resistor mounting slots is less than the number of light source mounting slots, a variant can be that at least one of the light source mounting slots does not lie electrically in parallel with one of the resistor mounting slots or cannot be bridged by way of one of the resistor mounting slots.

If the number of resistor mounting slots is greater than the number of light source mounting slots, at least one of the resistor mounting slots can also be used as an alternative means of bridging the light source mounting slots, e.g. instead of a plurality of other resistor mounting slots. Cost savings and a reduction in component insertion overhead can be achieved in this way.

It is a development that the light source mounting slots are arranged in a matrix pattern and light source mounting slots to which none of the resistor mounting slots is assigned are arranged in a central block of light source mounting slots. This allows a compact area for the light source mounting slots to be maintained for different population variants.

It is another development that a light source mounting slot has a contact surface for an anode of the light source, a contact surface for a cathode of the light source and a contact surface for a heat dissipation surface of the light source (‘thermal pad’), said contact surfaces being electrically isolated from one another. This enables light sources, in particular light-emitting diodes, that have a dedicated heat dissipation surface to be thermally coupled to the substrate particularly efficiently. Furthermore, a simple and space-saving possibility for routing through an electrical line can be provided by way of the contact surface for the heat dissipation surface, such that the electrical line consequently no longer needs to be routed externally around the mounting slot.

It is a special embodiment that a contact surface for an anode or a cathode of a light source mounting slot is electrically connected to a contact surface for an anode or a cathode of a further light source mounting slot, and moreover by way of a contact surface for a heat dissipation surface of at least one further light source mounting slot. This permits a particularly compact wiring scheme.

It is furthermore an embodiment that the light source mounting slots are populated with at least two groups of light sources of the same color in each case. Thus, the light source mounting slots can be populated at least with a first group of light sources of a first color in each case and with a second group of light sources of a second color in each case, e.g. red and mint green. Each of the groups of light sources has at least one light source. In a further variant it is also possible for three groups of light sources comprising three colors, e.g. red, green and blue, to be present, or even four groups, e.g. red, green, blue and amber. In general at least two groups can also be of the same color, e.g. two individually controllable groups having light sources of green color.

The light sources of at least two different groups can have a different color, and the light sources of at least one group are connected in series. In this way it is possible to achieve a simple bridging of and uniform supply of current to the light source mounting slots or, specifically, the light sources disposed therein.

It is also a development that the light sources of at least two different groups have a different color and that for at least one of the groups, in particular all of the groups, of light sources at least one light source mounting slot is not connected electrically in parallel with a resistor mounting slot. In this way it can be ensured that at least one light source of one of the groups is present.

It is a further embodiment that the light source mounting slots are populated with two groups of light sources of different color, that the light sources of the two groups are electrically connected in series in each case and that the two groups of light sources can be activated or switched in alternation. Such an embodiment can be implemented particularly easily, e.g. by means of an oppositely directed or alternate means of control, in particular by way of a different polarity of the control signal, in particular operating current. At least one control line can be provided for example for the control function.

For precise control it is advantageous if the groups can be activated or controlled using pulse width modulation, e.g. a first group having pulses of positive polarity alternating with a second group having pulses of positive polarity.

Generally the groups can be controlled independently of one another and e.g. be connected electrically in parallel with one another.

It is also an embodiment that the light sources can be switched or activated individually, in particular are switchable on and off or controllable and non-controllable, respectively. This can be achieved for example by provision of at least one control line. Accordingly, even already installed light sources can be activated individually, e.g. in order to set a time integral luminous intensity.

It is yet another embodiment that the light source mounting slots are populated with two groups of light sources having red and mint green color. This enables a variant to be realized which can embodied and controlled particularly simply and cheaply and which is capable of generating a white mixed light.

The object is also achieved by means of a lighting module having at least one such substrate.

The invention is described in greater detail below with reference to exemplary embodiments and the accompanying schematic figures. For clarity of illustration reasons, like or like-acting elements may be labeled therein with the same reference signs.

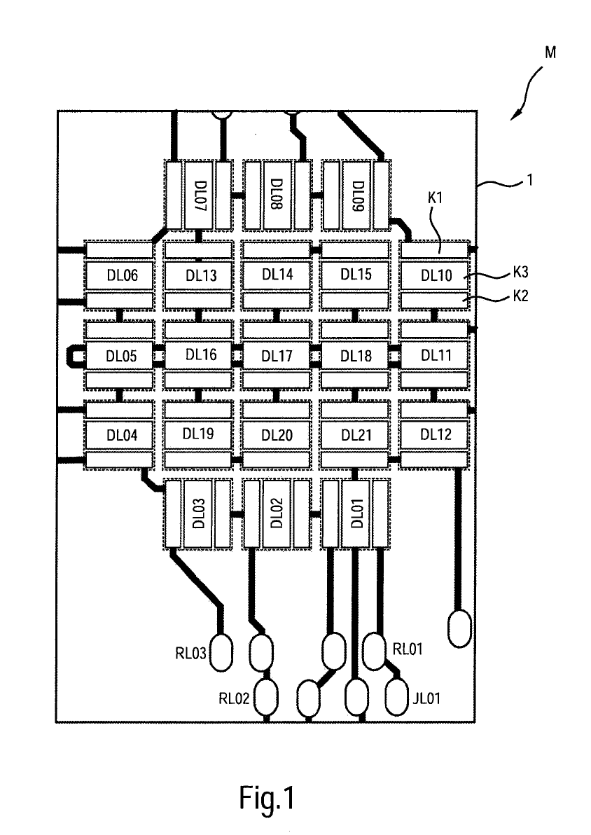

FIG. 1 shows a partial plan view onto a front side of a substrate according to a first embodiment variant, the substrate having a plurality of LED mounting slots and a plurality of resistor mounting slots, some of the LED mounting slots being populated with LEDs;

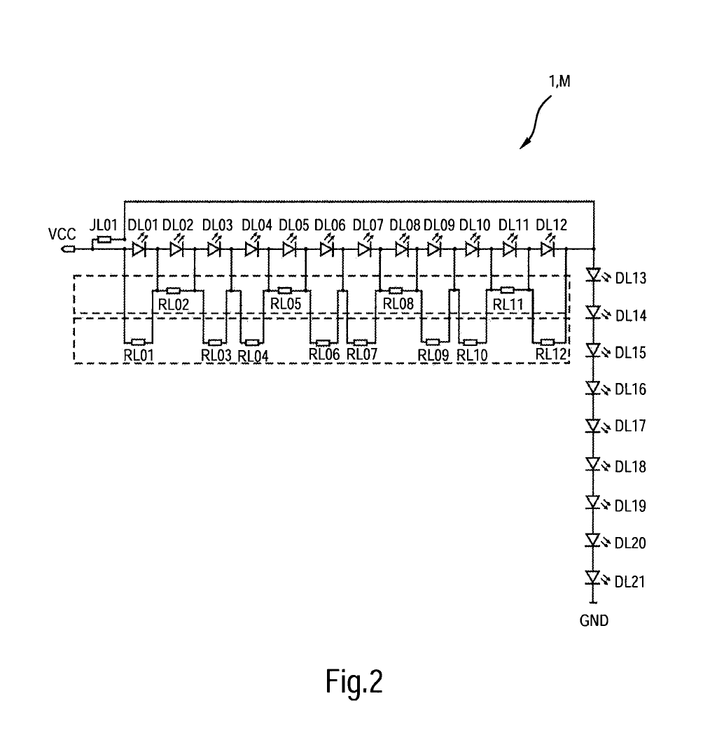

FIG. 2 shows a simplified circuit diagram of the substrate in the region of the LED mounting slots and resistor mounting slots;

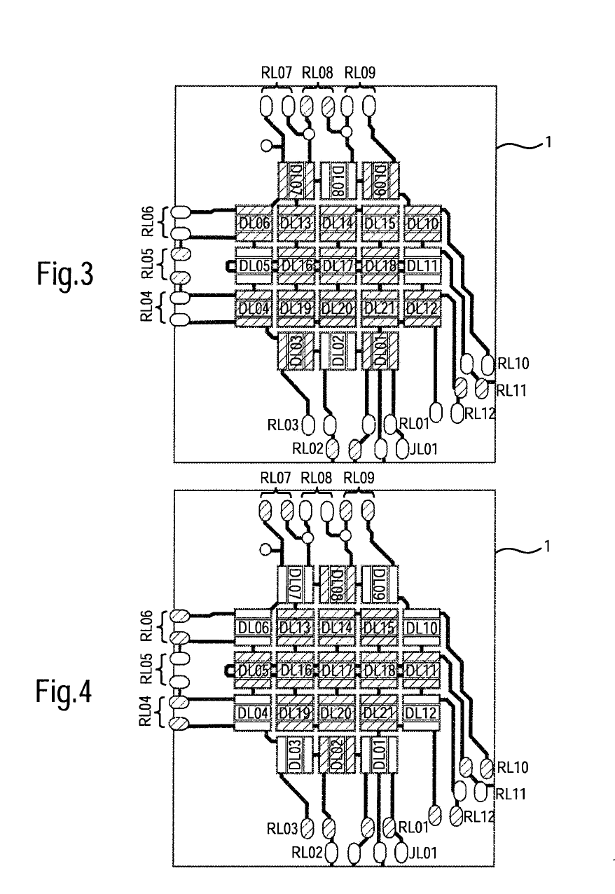

FIG. 3 shows a partial plan view onto the front side of the substrate according to the first embodiment variant, even more of the LED mounting slots now being able to be populated with LEDs;

FIG. 4 shows a partial plan view onto the front side of the substrate according to the first embodiment variant, other LED mounting slots now being able to be populated with LEDs;

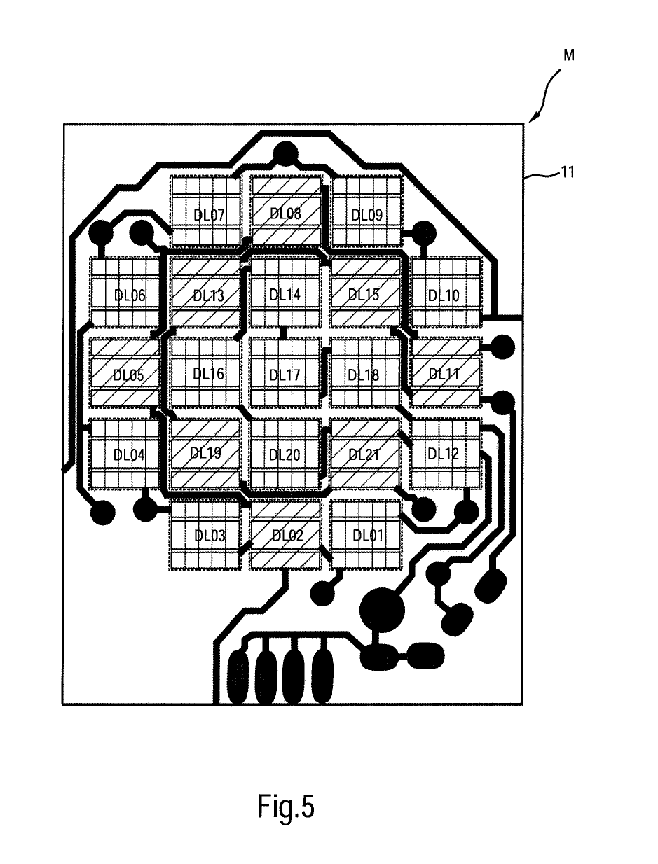

FIG. 5 shows a partial plan view onto the front side of a substrate according to a second embodiment variant, the LED mounting slots now being populated with LEDs of different color;

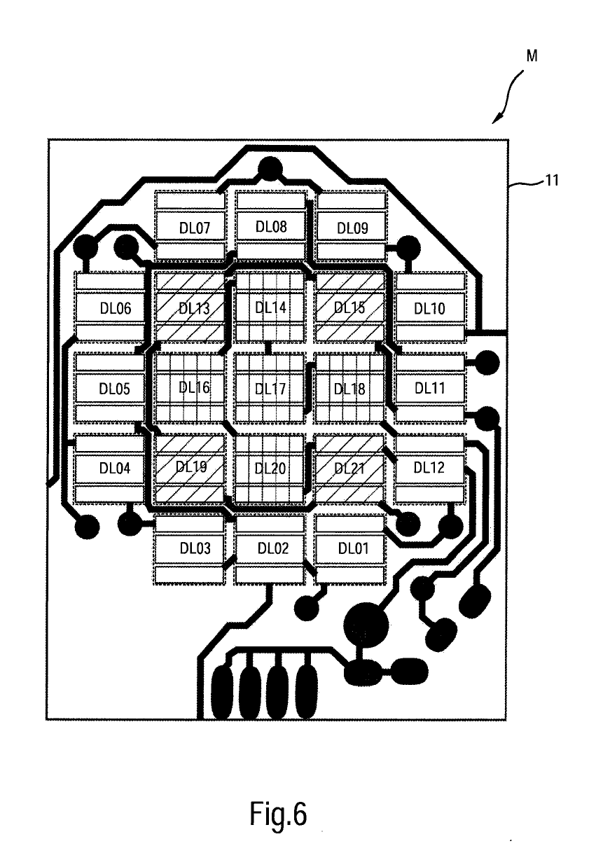

FIG. 6 shows a partial plan view onto the front side of the substrate, the LED mounting slots now being differently populated with LEDs of different color;

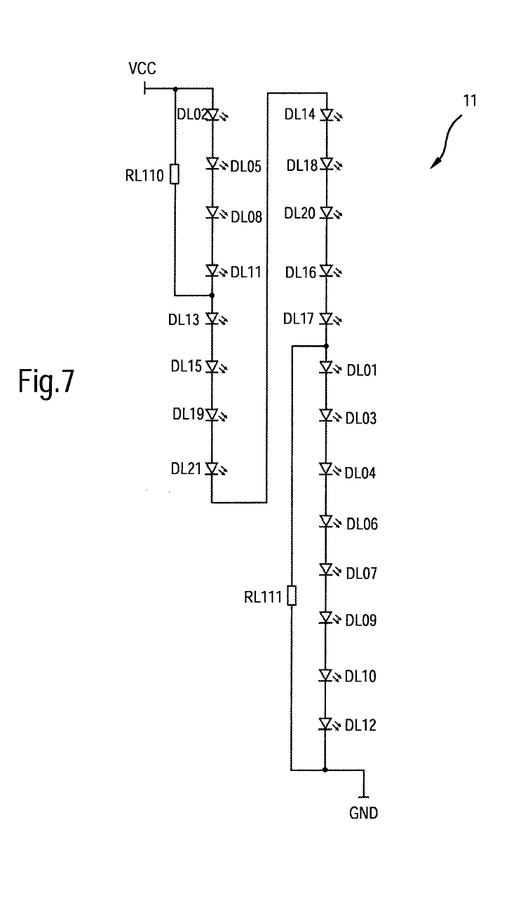

FIG. 7 shows a simplified circuit diagram of the substrate in the region of the LED mounting slots and resistor mounting slots for the configuration from FIG. 5 or FIG. 6; and

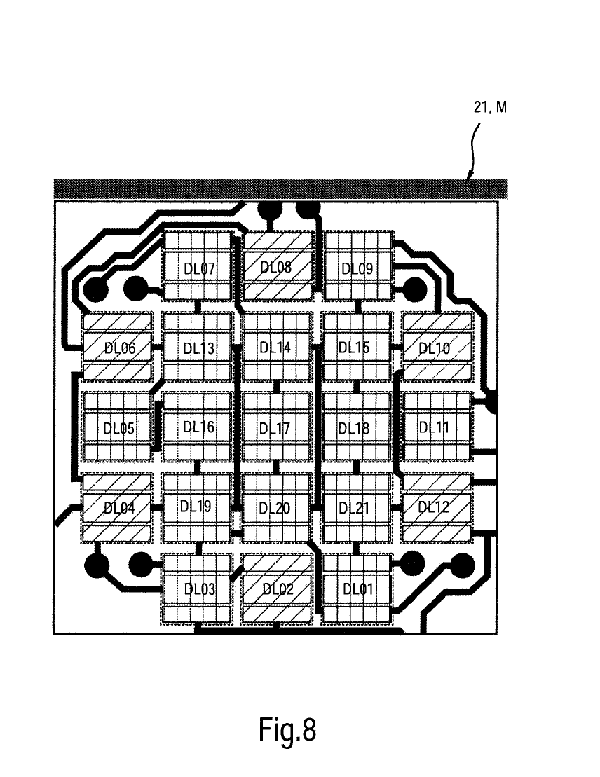

FIG. 8 shows a partial plan view onto the front side of a substrate according to a third embodiment variant, the LED mounting slots now being differently populated with LEDs of different color.

FIG. 1 shows a partial plan view onto a front side of a substrate 1 of a lighting module M according to a first embodiment variant, said substrate having twenty-one LED mounting slots DLn (n=01 to 21) and twelve resistor mounting slots RLm (m =01 to 12) for bridge resistors. Twelve of the LED mounting slots DL01 to DL12 are connected electrically in parallel with one of the twelve resistor mounting slots RL01 to RL12 in each case. Nine of the LED mounting slots DL13 to DL21 have no resistor mounting slot RLm assigned to them. Thus, the LED mounting slots DL01 to DL12 can be populated individually, or else not, while the mounting slots DL13 to DL21 are always populated.

The LED mounting slots DLn are arranged in the manner of a matrix on the substrate 1. In this arrangement the LED mounting slots DL13 to DL21 form a central block consisting of 3×3 elements, while the LED mounting slots DL01 to DL12 form an outer row at the sides thereof (without corner slots).

The LED mounting slots DLn each have three contact fields or contact surfaces (‘pads’), specifically one contact surface K1 on the outside in each case for an anode of a LED that is to be inserted and one contact surface K2 for a cathode of the LED that is to be inserted, as well as one contact surface K3 therebetween for a heat dissipation surface (‘thermal pad’) of the LED that is to be inserted. The contact surfaces K1, K2, K3 are electrically isolated from one another.

The resistor mounting slots RLm are positioned outside of the LED mounting slots DLn, with the result that in practice the resistor mounting slots RLm do not lie in a light emission cone of the LEDs that are to be inserted into the LED mounting slots DLn and consequently do not shadow any light radiation.

FIG. 2 shows a simplified circuit diagram of the substrate 1 in the region of the LED mounting slots DLn and the resistor mounting slots RLm. The LED mounting slots DLn are interconnected in series and electrically connected between a supply end VCC and ground GND. The twelve LED mounting slots DL01 to DL12 are connected electrically in parallel with one of the twelve resistor mounting slots RL01 to RL12 in each case.

Furthermore, the section comprising the LED mounting slots DL01 to DL12 is connected electrically in parallel with a further resistor mounting slot JL01. Advantageously, the resistor mounting slot JL01 is only populated, e.g. with a zero-ohm resistor, if only the LED mounting slots DL13 to DL21 are populated or are to be populated. A resistor disposed in the resistor mounting slot JL01 bridges all the LED mounting slots DL01 to DL12, thus reducing component insertion overhead and component costs.

At least one control line (not shown) may be present for outputting switching signals to the LEDs arranged in the LED mounting slots DLn. Said LEDs can be selectively activated for emitting light or turned off by means of the switching signals.

FIG. 3 shows a partial plan view onto the front side of the substrate 1, which is now configured such that the LED mounting slots DL02, DL05, DL08 and DL11 are not populated and the other LED mounting slots DL01, DL03, DL04, DL06, DL07, DL09, DL10 and DL12 as well as DL13 to DL21 are populated with LEDs (indicated by hatching).

In the circuit diagram from FIG. 2, this corresponds to a population of the resistor mounting slots RL02, RL05, RL08 and RL11, which in this case are shown as hatched and in FIG. 2 are represented schematically in the upper dashed box. The resistor mounting slots RL01, RL03, RL04, RL06, RL07, RL09, RL10 and RL12 shown in the lower dashed box in FIG. 2 are not populated and consequently are electrically interrupted. The resistor mounting slot JL01 is likewise not populated.

Accordingly, a current can flow from the supply end VCC, through the LED mounting slot DL01 (populated with a LED), through the resistor mounting slot RL02 (populated with a zero-ohm resistor), through the LED mounting slots DL03 and DL04, through the resistor mounting slot RL05, through the LED mounting slots DL06 and DL07, through the resistor mounting slot RL08, through the LED mounting slots DL09 and DL10, through the resistor mounting slot RL11, through the LED mounting slot DL12, and onward through the LED mounting slots DL13 to DL21, to ground GND.

A thus populated substrate 1 has seventeen LEDs. The substrate 1 can be a part of a LED lighting module M. The substrate 1 and/or the LED lighting module M can additionally have current terminals, an electronic circuit (e.g. a driver or a part thereof), at least one sensor (temperature sensor, photodetector, etc.) and further switching elements.

FIG. 4 shows the substrate 1 in a different population configuration relative to FIG. 3. In this case, complementary to FIG. 3, the LED mounting slots DL02, DL05, DL08 and DL11 as well as DL13 to DL21 are now populated with LEDs (indicated by hatching) and the LED mounting slots DL01, DL03, DL04, DL06, DL07, DL09, DL10 and DL12 are not populated. Accordingly, the resistor mounting slots RL02, RL05, RL08 and RL11 shown in the upper dashed box are not populated, while the resistor mounting slots RL01, RL03, RL04, RL06, RL07, RL09, RL10 and RL12 shown in the lower dashed box are populated, in particular with zero-ohm resistors (indicated by hatching).

In this case a current can flow from the supply end VCC through the resistor mounting slot RL01 (populated with a zero-ohm resistor), through the LED mounting slot DL02 (populated with a LED), through the resistor mounting slots RL03 and RL04, through the LED mounting slot DL05, through the resistor mounting slots RL06 and RL07, through the LED mounting slot DL08, through the resistor mounting slots RL09 and RL10, through the LED mounting slot DL11, through the resistor mounting slot RL12, and onward through the LED mounting slots DL13 to DL21, to ground GND. A thus populated substrate 1 has thirteen LEDs.

If the LEDs are LEDs of the same color, e.g. white LEDs, a luminous flux can be scaled simply based on the number of inserted LEDs, without any need to modify a layout of the substrate 1. The number of LEDs on the substrate 1 can be selected arbitrarily between nine and twenty-one.

The substrate 1 can have one or more population zones as described and/or the lighting module M can have one or more substrates 1.

FIG. 5 shows a partial plan view onto the front side of a substrate 11 according to a second embodiment variant, wherein the LED mounting slots DL01 to DL21 are now populated with twenty-one LEDs of in some cases different color, namely with thirteen mint-colored LEDs (LED mounting slots DL14, DL16, DL17, DL18, DL20, DL01, DL03, DL04, DL06, DL07, DL09, DL10 and DL12, hatched vertically) and eight red LEDs (LED mounting slots DL02, DL05, DL08, DL11, DL13, D15, DL19, DL21, hatched diagonally). This configuration of the LED lighting module M is very light-intensive.

An electrical transition between the red LEDs and the mint-colored LEDs is realized in the form of a line between the contact surfaces K1, K2 of the mounting slots DL20 and DL21. This transition can also be regarded as a transition between circuit-separated regions which can be controlled separately. For example, said circuit-separated regions can in each case comprise LEDs of the same color.

FIG. 6 shows a partial plan view onto the front side of the substrate 11, with now only the nine inner LED mounting slots DL13 to DL21 being populated with LEDs of different color, namely five mint-colored LEDs (LED mounting slots hatched vertically) and four red LEDs (LED mounting slots hatched diagonally). This configuration of the LED lighting module M is cheaper than the configuration shown in FIG. 5.

FIG. 7 shows a simplified circuit diagram of the substrate 11 in the region of the resistor mounting slots R110 and R111 for the configuration from FIG. 5 and FIG. 6. In this case the LED mounting slots DL13, D15, DL19, DL21 (for the red LEDs) and DL14, DL16, DL17, DL18, DL20 (for the mint-colored LEDs) cannot be bridged. The remaining LED mounting slots DL02, DL05, DL08 and DL11 for the red LEDs cannot be bridged individually, but only collectively by way of a resistor mounting slot RL110. The substrate 11 also has a resistor mounting slot RL111 which can collectively bridge the remaining LED mounting slots DL01, DL03, DL04, DL06, DL07, DL09, DL10 and DL12 for the mint-colored LEDs. Thus, the LED mounting slots DL02, DL05, DL08 and DL11 or, as the case may be, DL01, DL03, DL04, DL06, DL07, DL09, DL10 and DL12 can in each case be activated as a group. With resistor mounting slots RL110 and RL111 unpopulated and correspondingly populated LED mounting slots DL02, DL05, DL08 and DL11 as well as DL01, DL03, DL04, DL06, DL07, DL09, DL10 and DL12, the arrangement shown in FIG. 5 can result. With resistor mounting slots RL110 and RL111 populated and correspondingly unpopulated LED mounting slots DL02, DL05, DL08 and DL11 as well as DL01, DL03, DL04, DL06, DL07, DL09, DL10 and DL12, the arrangement shown in FIG. 6 can be produced.

The red LEDs of the LED mounting slots DL02, DL05, DL08, DL11 DL13, D15, DL19, DL21 and the mint-colored LEDs of the LED mounting slots DL14, DL16, DL17, DL18, DL20, DL01, DL03, DL04, DL06, DL07, DL09, DL10 and DL12 are controllable separately. This can happen for example by way of at least one control line (not shown) to the LEDs which can apply e.g. a PWM signal to same-colored LEDs in order to collectively deactivate (turn off or switch to dark) or activate said LEDs for the duration of the PWM pulse. The two groups of LEDs can be controlled e.g. by way of PWM pulses of different polarity.

FIG. 8 shows a partial plan view onto the front side of a substrate 21 according to a third embodiment variant, the LED mounting slots DLn in turn being populated with LEDs of different color. However, the nine inner mounting slots DL13 to DL21 are now populated with LEDs of a common color, e.g. mint green (vertical hatching), while the outer LED mounting slots are populated with six LEDs of this color and six LEDs of a different color (diagonal hatching), e.g. red.

It is self-evident that the present invention is not limited to the exemplary embodiments shown.

Thus, colors other than red and mint green can also be used, e.g. the three colors red, green and blue.

In general LEDs of the same color can be controlled separately from the LEDs of a different color.

### LIST OF REFERENCE SIGNS

1 Substrate

11 Substrate

21 Substrate

DLn LED mounting slot

K1 Contact surface

K2 Contact surface

K3 Contact surface

RLm Resistor mounting slot

JL01 Resistor mounting slot

M LED lighting module

VCC Supply end

GND Ground

1. A substrate for a lighting module, said substrate comprising a plurality of light source mounting slots, and at least one resistor mounting slot for a bridge resistor, wherein the at least one resistor mounting slot is in each case connected in parallel with at least one of the light source mounting slots.

2. The substrate as claimed in claim 1, wherein more light source mounting slots are present than resistor mounting slots.

3. The substrate as claimed in claim 1, wherein the light source mounting slots are arranged in a matrix pattern and light source mounting slots to which none of the resistor mounting slots is assigned are arranged in a central block of the light source mounting slots.

4. The substrate as claimed in claim 1, wherein a light source mounting slot has a contact surface for an anode of the light source, a contact surface for a cathode of the light source and a contact surface for a heat dissipation surface of the light source, the contact surfaces being electrically isolated from one another.

5. The substrate as claimed in claim 4, wherein a contact surface for an anode or a cathode of a light source mounting slot is electrically connected to a contact surface for an anode or a cathode of a further light source mounting slot, and moreover by way of a contact surface for a heat dissipation surface of at least one further light source mounting slot.

6. The substrate as claimed in claim 1, wherein the light source mounting slots are populated with at least two groups of light sources of the same color in each case, wherein the light sources of at least two different groups have a different color, and wherein the light sources of at least one group are connected in series.

7. The substrate as claimed in claim 6, wherein the light source mounting slots are populated with at least two groups of light sources of the same color in each case, wherein the light sources of at least two different groups have a different color and wherein for at least one of the groups of light sources at least one light source mounting slot is not connected electrically in parallel with a resistor mounting slot (RLn).

8. The substrate as claimed in claim 6, wherein the two groups of light sources can be activated in alternation.

9. The substrate as claimed in claim 1, wherein the light sources can be switched individually.

10. The substrate as claimed in claim 1, wherein the light source mounting slots are populated with two groups of light sources of red and mint green color.

11. The substrate as claimed in claim 1, wherein a distance between adjacent light sources ranges between 0.05 mm and 1 mm.

12. The substrate as claimed in claim 1, wherein an edge length of the area occupied by the light sources does not exceed 21 mm.

13. A lighting module comprising at least one substrate as claimed in claim 1.

14. The substrate as claimed in claim 1, wherein said light source mounting slots are LED mounting slots.
